(19) United States
(12) Patent Application Publication
(10) Pub. No.: US 2013/0152756 A1
(43) Pub. Date: Jun. 20, 2013

(54) Jig for Trimming Counter Corners

(71) Applicant: David C. King, Lexington, SC (US)

(72) Inventor: David C. King, Lexington, SC (US)

(21) Appl. No.: 13/532,438

(22) Filed: Jun. 25, 2012

Related U.S. Application Data
(63) Continuation of application No. 12/658,249, filed on Feb. 5, 2010, now abandoned.
(60) Provisional application No. 61/207,129, filed on Feb. 9, 2009.

(51) Int. Cl. B26D 7/01

(52) U.S. Cl. CPC B26D 7/015
USPC 83/466.1

(57) ABSTRACT

A board war gaming hobbyist's jig for trimming the corners of game counters consists of two 1″×¾″ beveled flanges glued onto a 1½″ square, clear plastic base so that they are at right angles, spaced-apart and with their beveled edges laying in the same plane. A felt or high-density foam backing is adhered to the bottom of the base to provide scratch protection and to add color to the piece, if desired. Counters may be stacked and their aligned corners pushed into the corner defined by the two spaced-apart flanges. The corners of the counters may be trimmed by sliding the blade of a hobby knife against the beveled edges of the flanges. The present jig enables the rough corners of the counters to be trimmed quickly, neatly and consistently.

### PRIORITY CLAIM

This application is a continuation of U.S. non-provisional patent application Ser. No. 12/658,249, filed Feb. 5, 2010. Priority is claimed to U.S. provisional patent application Ser. No. 61/207,129, filed Feb. 9, 2009, which is incorporated herein in its entirety by reference.

### BACKGROUND OF THE INVENTION

The present invention relates to small, pasteboard counters used in certain box games, particularly board war games. The U.S. board war gaming hobby began in 1955. Still today, two things remain common to virtually all of the games: a map sheet playing surface and cardboard counters (½″ to 1″ printed, die-cut squares). These counters are punched or cut loose from cardboard frames, usually leaving ragged corners. Players trim these corners off, one counter at a time, one corner at a time, in a process called “counter clipping; nail clippers are the primary tool. Given that some games contain up to 3,000 counters, it is a long, tedious process.

The present invention addresses these shortcomings.

### SUMMARY OF THE INVENTION

The present invention is a jig invented specifically for trimming the corners of counters used in war games. This jig, when used with a sharp knife or cutting tool, dramatically speeds up this process. Users can stack up to 10 counters in the present jig and trim one corner of each counter in the stack all at once using a common hobby knife, such as that sold under the trademark X-ACTO, manufactured by X-ACTO, a division of Elmer's Products, Inc. This means that the typical game of 400 to 500 counters can be prepared in under an hour, instead of the several hours required using nail clippers.

### BRIEF DESCRIPTION OF THE DRAWINGS

The accompanying drawings, which are incorporated in and form a part of the specification, illustrate preferred embodiments of the present invention and, together with the description, disclose the principles of the invention. In the drawings:

FIG. 1 is a top, perspective view of the jig, according to an embodiment of the present invention;

FIG. 2 is a top view of the jig of FIG. 1, according to an embodiment of the present invention;

FIG. 3 is a side view of the jig of FIG. 1, according to an embodiment of the present invention; and

FIG. 4 is another side view of the jib of FIG. 1 taken along lines 4-4 of FIG. 2, according to an embodiment of the present invention.

### DETAILED DESCRIPTION OF EMBODIMENTS OF THE INVENTION

The present jig 10 is comprised of certain materials and is ideally made using particular tools.

Its primary components, a base 12 and two beveled flanges 14, 16, may be made of a solid, rigid material, preferably a plastic and most preferably a transparent plastic, such as that sold under the trademark PLEXIGLAS, manufactured by Arkema France, preferably 0.56 cm (0.22 inches) in thickness and have a felt or high-density foam backing 18 which may be a square that is 4.45 cm (1¾ inches) on a side, coated with a suitable adhesive. Felt or foam backing 18 comes in an assortment of colors. Cyanoacrylate glue sold under the trademark SUPERGLUE sold by Chemence, Inc., is preferred to affix the components.

The base 12 and flanges 14, 16, may be cut with a table saw and sanded with a bench-top circular sander. The user of the present jig 10 will need a sharp hobby knife such as an X-ACTO hobby knife with a heavy-duty handle and several blades, such as No. 18 blades.

In addition, to assemble the components, the manufacturer may need a butane mini torch, a holding clamp, a square which may be of the machinist's type, and an assembly jig, as will be described below.

Finally, the manufacturer may want to have 0.8 cm ( 5/16 inch) plastic “L” strips, 0.95 cm (⅜ inch) square wood doweling, sandpaper which may be 150 grit, and a file.

The first step in the method for making the present jig 10 is to set the table saw to have a 3.8 cm (1.5 inch) width cut. Cut a strip of the plastic or other material of which the base is to be made. Reposition the strip perpendicular to the saw blade and cut the strip to form a 3.8 cm (1.5 inch) square which will form the base 12 for the present jig 10.

Next adjust the table saw for a 2.5 cm (1 inch) width cut. Cut a strip of the plastic or other material of which flanges 14, 16 are to be made. Set the table saw for a 1.25 cm (¾ inch) width cut. Then reposition the strip perpendicular to the saw blade and cut the strip twice to form two 2.5 cm×1.25 cm (1 inch×¾ inch) pieces, which will become flanges 14, 16. Flanges 14, 16 will be rectangular solids at this stage.

Using the bench sander with a circular sander, set the bend table to be perpendicular to the circular sander. Sand all four sides of base 12, checking finished pieces to ensure they are square. Repeat the process for the flanges 14, 16 so that their sides are flat. Then adjust table to 45 degree angle and sand one 1.25 cm (¾ inch) end of each flange 14, 16 until the remaining flat tip is 1.6 mm ( 1/16 inch) thick to define beveled ends 20, 22. Using 150-grit sandpaper laid flat on a workbench, sand any remaining flashing or sharp edges from beveled ends 20, 22, of flanges 14, 16. Due to kerf in cutting, sanding, etc., flanges 14, 16 may not be precisely the same size.

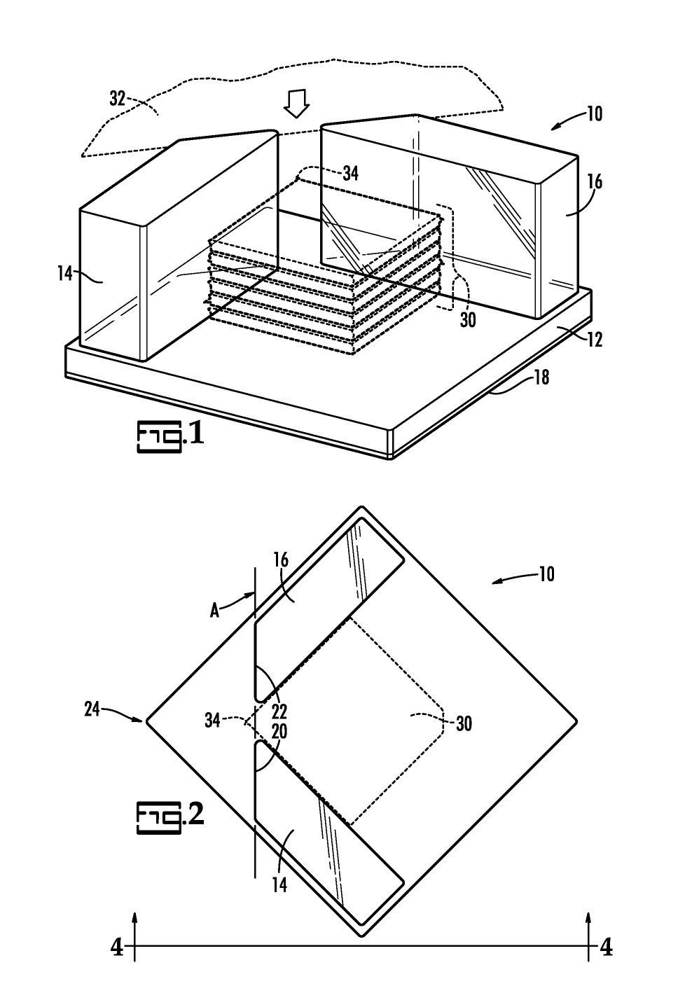

Using the holding clamp and butane mini-torch set on medium flame setting, anneal all four edges of base 12. For flanges 14, 16, anneal only one long edge (top) and the short edge opposite the bevel. Do not anneal the beveled edge or the one long bottom edge. Note that flanges 14, 16 are the same shape but one will be used as left flange 14 and the other will be used as right flange 16. Position flanges 14, 16, on base 12, as shown in FIG. 1 to identify the top of each flange 14, 16, that is to be annealed.

To assemble the present jig 10, stand flanges 14, 16, on base 12 so they are perpendicular to each other with their respective beveled edges 20, 22, spaced-apart, facing one corner 24 of base 10 and lying in the same plane along line A (FIG. 2. Use a 7.6 cm (3 inch) machinist's square to ensure each flange 12, 14, stands at 90-degree vertical. Use the file to hone the bottom edges of flanges 12, 14, as needed.

Run a small bead of cyanoacrylate glue along the un-annealed bottom edge of flange 14, then position it on base 12 as shown in FIG. 1; hold it in place for 10 seconds. Repeat for flange 16. Set jig 10 aside for a minimum of 3 hours to allow complete drying and curing of the cyanoacrylate glue.

With the square piece of adhesive-backed felt or high-density foam for backing 18, a microfiber or polishing cloth, a razor blade holder (scraper), and jig 10, use the cloth to clean all surfaces of jig 10. Peel the release backing off felt 18 and lay it on a flat surface, adhesive side up. Firmly press the bottom of jig 10 onto the adhesive backing.

Use the razor blade to trim excess felt 18 from jig 10 so that the backing is flush with the edge of the base 12 of jig 10. Using thumb and fore finger, press the material more firmly to the base 12. Wipe again with the polishing cloth.

To create an assembly jig, cut a ⅜″ square wood dowel to a length of 2.5 cm (1 inch) and cut a 0.8 cm ( 5/16 inch) L-shaped plastic strip to a 3 cm (1 3/16 inch) length. Glue the plastic strip to the wood dowel so the plastic is flush with one end of the dowel. Let it dry. Draw or etch a thin black line perpendicular to the length of the dowel 0.26 cm ( 3/32 inch) from the front, all-wood corner, on both sides of the corner. This is a guideline against which flanges 14, 16, are placed and assures that flanges 14, 16 are separated by just enough so only a small corner 34 of a stack of counters 30 extends beyond the plane A defined by the beveled ends 20, 22, of flanges 14, 16. Jig is complete. Note: this is an aid to assembly and not part of the present invention itself, for which patent protection is claimed.

A 1.9 cm (¾ inch) long piece of 0.8 cm ( 5/16 inch) L-shaped plastic strip may assist in holding counters 30 in position on jig 10, although it is not actually part of jig 10, nor is it necessary for use of the present jig 10.

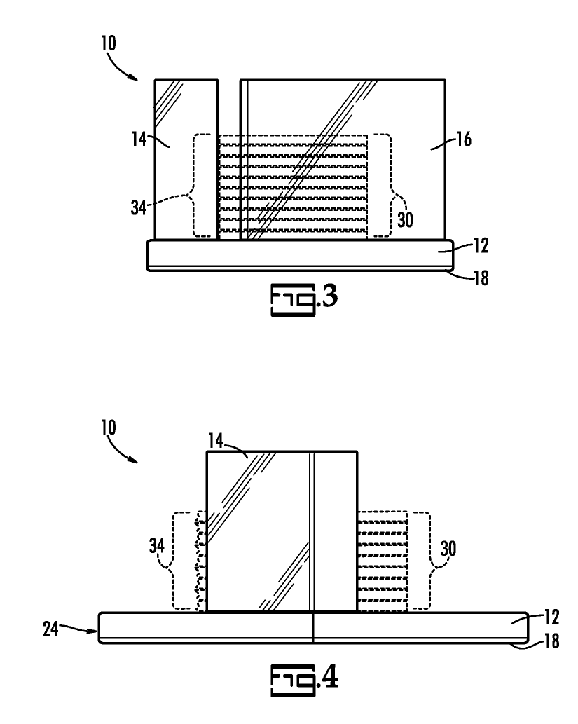

With base 12 of the jig 10 on a flat surface, such as a table, stack 6 to 10 untrimmed counters 30 against flanges 14, 16, with one corner 34 of the stack of counters 30 protruding through the opening between the beveled edges 20, 22, of flanges 14, 16, as shown in FIGS. 1-4. Hold counters 30 firmly in place with thumb and index finger (the L-shaped plastic piece described above can make this easier). Using a hobby knife with heavy-duty handle and a no. 18 blade 32 (or similar), place the un-honed edge of blade 32 flat simultaneously against both of the upper ends of beveled edges 20, 22, of flanges 14, 16 at line A (FIG. 2), at a level above the stack of counters 30 and push the blade 32 straight down, while holding it in contact with both beveled edges 20, 22, to trim corners 34 off the counters 30. Turn the stack by 90° and repeat for the remaining three corners 34. This completes the process of trimming corners 34 for one stack of counters 30.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention. For example, components may be cut with lasers rather than saws to meet higher production runs. It will be apparent to those skilled in the art of manufacturing game pieces and game-related accessories that many changes and substitutions may be made to the foregoing description of preferred embodiments without departing from the spirit and scope of the present invention, which is defined by the appended claims.

While various embodiments of this invention have been described above, these descriptions are given for purposes of illustration and explanation. Variations, changes, modifications, and departures from the systems and methods disclosed above may be adopted without departure from the spirit and scope of this invention.

What is claimed is:

1. A jig for trimming a corner of a counter with a blade, comprising:
(a) a base; and
(b) two flanges with flat sides, mounted spaced-apart, perpendicular to said base and perpendicular to each other, each flange of said two flanges having a beveled edge, said flanges arranged so that said beveled edges of said two flanges lay in the same plane so that when a counter is placed against said two flanges so that said corner of said counter extends between said two spaced-apart flanges and crosses said plane, and a blade is slid across said beveled edges, said corner of said counter is trimmed.

2. The jig as recited in claim 1, further comprising a backing made of felt or foam adhered to said base.

3. The jig as recited in claim 1, wherein said base and said flanges are made of transparent resinous plastic.
